(19) United States
(12) Patent Application Publication
(10) Pub. No.: US 2006/0228034 A1
(43) Pub. Date: Oct. 12, 2006

(54) Digital diaphragm system

(75) Inventors: Yusuke Mizuno, Osaka (JP); Yusuke Nara, Osaka (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: MegaChips LSI Solutions Inc., Osaka-shi (JP)

(21) Appl. No.: 11/392,747

(22) Filed: Mar. 30, 2006

(30) Foreign Application Priority Data
Apr. 6, 2005 (JP) 2005-109703

(51) Int. Cl. G06K 9/00

(52) U.S. Cl. 382/251

(57) ABSTRACT

A digital diaphragm system is provided which is capable of realizing a focusing effect without using a diaphragm mechanism while greatly reducing the amount of data processing and shortening the processing time. With regions of interest set in an image a digital diaphragm effect is applied to the image by compressing the image such that the regions of interest in the image are assigned relatively larger amounts of code and are relatively in focus, such that a region of no-interest in the image is assigned a relatively smaller amount of code and is relatively out of focus, and such that lower-priority ones of the regions of interest are assigned relatively smaller amounts of code and relatively more out-of-focus.

### BACKGROUND OF THE INVENTION

1. Field of the Invention

The present invention relates to a digital diaphragm system applicable to a digital diaphragm of a digital camera.

2. Description of the Background Art

With a digital camera equipped with a diaphragm mechanism (a mechanism that adjusts the depth of field), the diaphragm mechanism provides an effect of focusing on the target object (an effect to focus on the target object to render it distinct while making the background unclear), which makes the image more expressive. On the other hand, a digital camera having no diaphragm mechanism achieves the focusing effect in a virtual way by image processing (digital diaphragm).

However, such digital cameras with diaphragm mechanisms are unavoidably large in size, and therefore have the disadvantage that they are difficult to mount in very small-sized cameras such as mobile camera phones, and the focusing effect cannot be sufficiently obtained with small, CCD-sized, digital cameras such as compact digital cameras.

Also, while conventional systems that virtually express the focusing effect by image processing use dedicated image processing devices, they require huge amounts of data processing and long processing time.

### SUMMARY OF THE INVENTION

An object of the present invention is to provide a digital diaphragm system that is capable of realizing a focusing effect without using a diaphragm mechanism, while greatly reducing the amount of data processing and shortening the processing time.

A digital diaphragm system includes region-of-interest setting means for setting a region of interest in an image; and image compression means for applying a digital diaphragm process to the image by performing an image compression in such a way that the region of interest in the image is assigned a relatively large amount of code and is relatively in focus and a region of no-interest in the image is assigned a relatively small amount of code and is relatively out of focus.

According to the digital diaphragm system, the digital diaphragm (focusing effect) is implemented by image compression and thus the focusing effect is realized without using a diaphragm mechanism. Also, the digital diaphragm is applied at the same time as the image compression and so the amount of data processing and the processing time are greatly reduced.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram schematically showing the configuration of a digital camera according to a preferred embodiment of the present invention;

FIG. 2 is a diagram showing an example of setting of regions of interest;

FIG. 3 is a diagram showing an example of a thumbnail image;

FIG. 4 is a diagram illustrating binarization of the thumbnail image;

FIG. 5 is a block diagram illustrating the configuration of an image compression module;

FIG. 6 is a diagram illustrating bit shifting;

FIG. 7 is a diagram illustrating setting of regions of interest in sub-bands;

FIG. 8 is a diagram illustrating operations of the digital camera of the preferred embodiment of the invention;

FIG. 9 is a diagram showing an example of a thumbnail image subjected to digital diaphragm processing;

FIG. 10 is a diagram illustrating AF judge blocks set in an image according to a first modification;

FIG. 11 is a diagram showing an example of an object image according to a second modification;

FIG. 12 is a diagram illustrating a method of extracting block images from an image according to the second modification;

FIG. 13 is a diagram illustrating a method of extracting block images at each candidate position according to the second modification;

FIGS. 14A to 14C are diagrams showing an example of a template image T, a Log-Polar transformed template image TL, and a pattern image PLT according to a third modification;

FIGS. 15A to 15G are diagrams illustrating the flow of processing of the third modification;

FIG. 16 is a schematic diagram showing a two-dimensional image subjected to a DWT of cubic decomposition levels according to an octave division scheme;

FIG. 17 is a schematic diagram illustrating n bit planes forming a code block; and

FIGS. 18 to 20 show tables of values of Energy weighting factors.

### DESCRIPTION OF THE PREFERRED EMBODIMENTS

### Preferred Embodiment

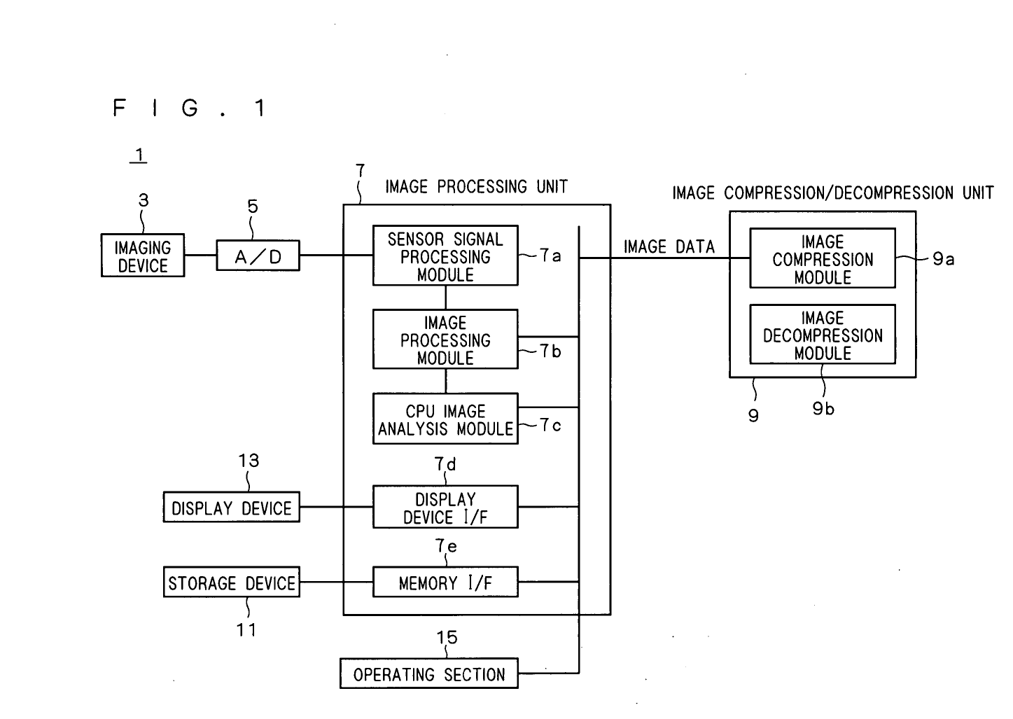

FIG. 1 is a block diagram simply illustrating a digital camera equipped with a digital diaphragm system according to the present invention.

As shown in FIG. 1, the digital camera 1 includes an imaging device 3 such as a CCD or CMOS, an A/D converter 5 for A/D converting an image signal provided from the imaging device 3, an image processing unit 7 for generating full image data and thumbnail image data from the image signal A/D converted by the A/D converter 5, an image compression/decompression unit 9 for applying image compression, while effecting digital diaphragm, to the image data generated by the image processing unit 7 and for applying image decompression to the compressed image data, a storage device (e.g., SDRAM) 11 for storing full image data and thumbnail image data after or before image-compressed, a display device 13 for displaying thumbnail images (preview images), and an operating section 15 for accepting camera operations.

The operating section 15 includes an image taking button, a switch for turning on/off the digital diaphragm function, a switch for switching a region-of-interest setting mode, which will be described later, between an automatic setting mode and a manual setting mode, a button for setting the image resolution or the amount of image data of full image data, a button for giving an instruction to store taken images, and the like.

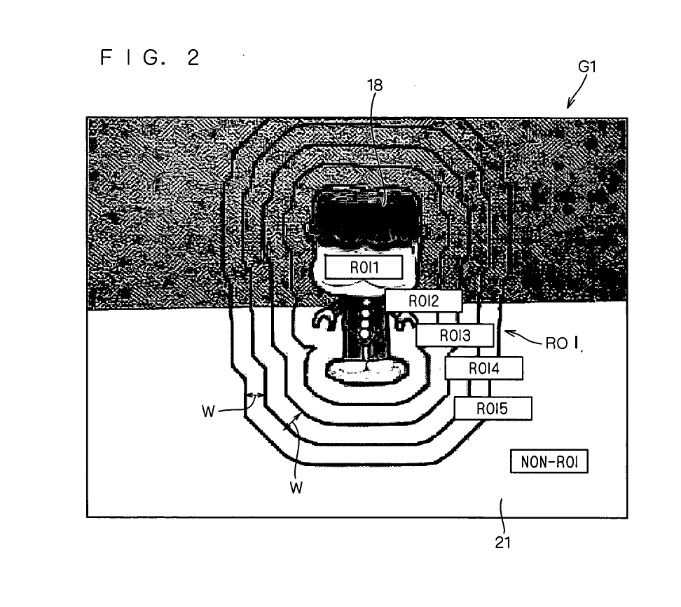

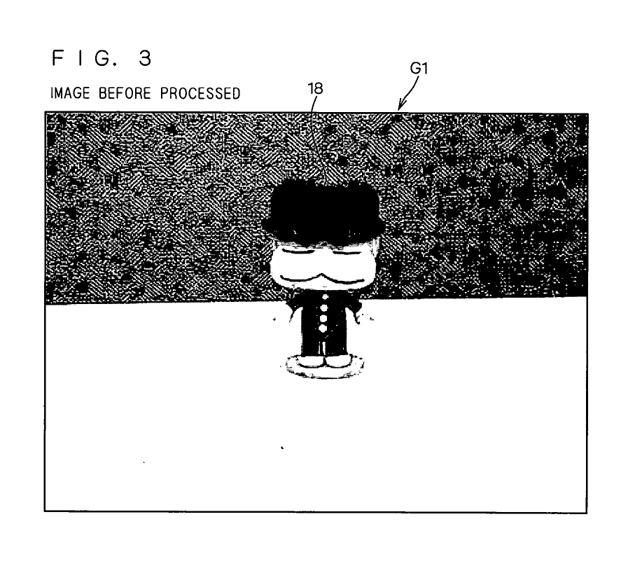

The image processing unit 7 includes a sensor signal processing module 7a for applying pre-processing (white balance, black level correction, etc.) to the image signal provided from the imaging device 3, an image processing module 7b for applying given image processes (pixel interpolation, tone correction, contour emphasis, etc.) to the image signal pre-processed in the sensor signal processing module 7a and generating full image data and thumbnail image data corresponding to the full image data, an image analysis module (object extracting means) 7c for, (a) in the automatic region-of-interest setting mode, extracting by image analysis an object (herein, a characteristic object (particular object)) 18 from a thumbnail image G1 (FIG. 3) and setting regions of interest ROI (FIG. 2) to that object 18, and (b) in the manual region-of-interest setting mode, setting regions of interest ROI in a desired area of the thumbnail image G1 on the basis of operation from the operating section 15, a display device I/F 7d, and a memory I/F 7e.

In this example, as shown in FIG. 2, for instance, the regions of interest ROI include a highest-priority region of interest ROI1 that is set on the area occupied by the object 18 and that is assigned the highest priority, and one or more (in FIG. 2, four) ring-like regions of interest ROI2 to ROI5 that are set like the growth rings of a tree around the highest-priority region of interest ROI1 and that are assigned priorities such that an outer one has a lower priority than the adjacent inner one. When regions of interest overlap (for example, when a plurality of characteristic objects close to each other are extracted and their regions of interest overlap), the overlapping portion is assigned the higher one of the priorities.

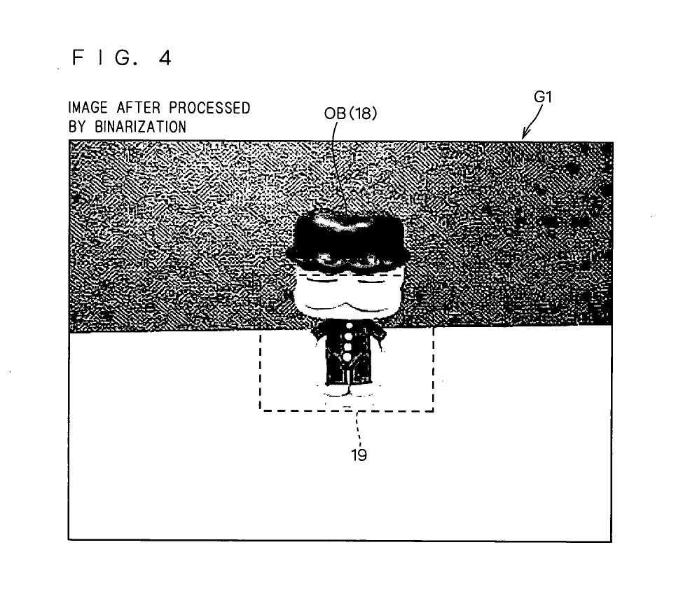

More specifically, in the process (a) above (i.e., in a mode that automatically sets regions of interest), the image analysis module 7c extracts all objects OB (FIG. 4) from the thumbnail image G1 (FIG. 3) by, e.g., binarization, and, among the extracted objects OB, it defines an object OB located in the center of the thumbnail image G1 (in the block 19 located in the center) as the characteristic object 18 mentioned above. Then, as shown in FIG. 2, the image analysis module 7c sets the highest-priority region of interest ROI1 in the portion that the object 18 occupies, and also sets the ring-like regions of interest ROI2 to ROI5 outside of the highest-priority region of interest ROI1 according to a previously determined width W, number, and priority order of the ring-like regions of interest.

In the process (b) above (i.e., in a mode that manually sets regions of interest), the image analysis module 7c sets the highest-priority region of interest ROI1 and its priority on an object (a rectangular or circular region) 18 that is set on the thumbnail image G1 through operation of the operating section 15, and also sets the ring-like regions of interest ROI2 to ROI5 outside of the highest-priority region of interest ROI1 according to a number (e.g., four), width W, and priority order of the ring-like regions of interest specified from the operating section 15.

When the digital diaphragm function is on, the image analysis module 7c applies the processes (a) and (b) to a thumbnail image G1 that has been automatically captured in response to a depression of the image taking button in the operating section 15 and generated by the image processing module 7b. On the other hand, when the digital diaphragm function is off, the image analysis module 7c applies the processes (a) and (b) to an image selected through the operating section 15 from among thumbnail images G1 stored in the storage device 11 in uncompressed form.

The image compression/decompression unit 9 includes an image compression module (image compression means) 9a for compressing input images provided from the image processing unit 7 (thumbnail images or full images) and an image decompression module 9b for decompressing images that have been compressed in the image compression module 9a.

The image compression module 9a applies the image compression to an input image provided from the image processing unit 7 while effecting the digital diaphragm, by compressing the image in such a way that relatively large amounts of code are assigned to the regions of interest so that they are relatively in focus, and a relatively small amount of code is assigned to the region of no-interest so that it is relatively out of focus, with lower-priority regions of interest being assigned relatively smaller amounts of code and relatively more out-of-focus.

In this example, as shown in FIG. 5, for instance, the image compression module 9a includes a DC level shifting block 102, a color space transform block 103, a tiling block 104, a DWT block 105, a quantization block 106, an ROI block (region-of-interest setting means) 51, a coefficient bit modeling block 108, an arithmetic coding block (entropy coding block) 109, a code rate control block 110, an image quality control block 52, and a bit stream generating block 111. All or part of the processing components of the image compression module 9a may be formed of hardware, or a program or programs for causing a microprocessor to function.

The image compression module 9a employs, for example, the JPEG 2000 as image compression techniques, and as shown in FIG. 5, image data inputted from the image processing module 7 of FIG. 1 to the image compression module 9a undergoes, as needed, DC level shifting in the DC level shifting block 102, and is then inputted to the color space transform block 103. The color space transform block 103 applies color space transform to the image data inputted from the DC level shifting block 102. As for the color space transform, the JPEG 2000 system prepares Reversible Component Transformation (RCT) and Irreversible Component Transformation (ICT), and one of them may be selected appropriately. Thus, the input RGB signal is transformed into a YCbCr signal or a YUV signal.

The tiling block 104 divides the image data inputted from the color space transform block 103 into a plurality of rectangular-shaped region components called “tiles”. It is not essential to divide the image data into tiles, and one frame of image data outputted from the color space transform block 103 may be intactly inputted to the DWT block 105.

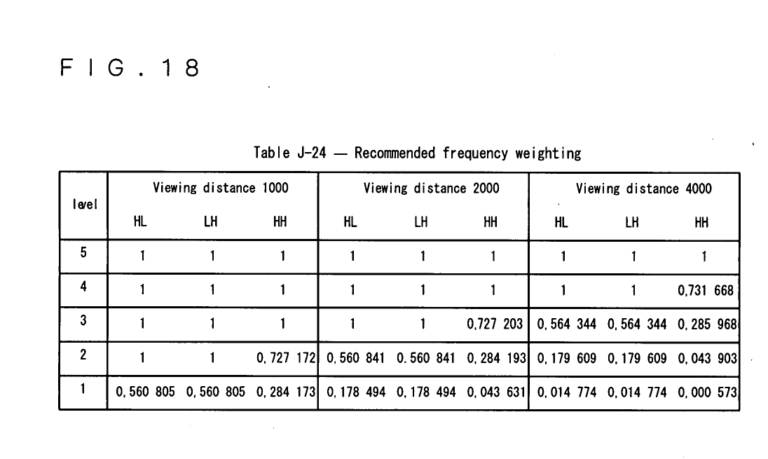

The DWT block 105 applies an integer type or real-number type wavelet transform (DWT) on a tile basis, to the image data inputted from the tiling block 104. Thus, the image data is recursively band-divided (frequency-divided) into high-band and low-band components according to an octave division scheme. As a result, as shown in FIG. 16, transform coefficients of a plurality of band components (sub-bands: frequency components) with different resolutions are generated. More specifically, a real-number DWT uses filters of, e.g., 9×7 taps, 5×3 taps, or 7×5 taps, and an integer DWT uses filters of, e.g., 5×3 taps or 13×7 taps. These filter processing may be achieved by convolution, or by lifting scheme that is more efficient than convolution.

With the transform coefficients of each sub-band of the input image, the DWT block 105 omits part or all of higher sub-band transform coefficients according to an image resolution or the amount of image data specified from the operating section 15, thereby optimizing the wavelet transform to the input image according to the specified image resolution or amount of image data.

When the input image is a thumbnail image, the DWT block 105 omits higher sub-bands (herein, with decomposition level 4, 1HH, 1LH, 1HL, 2HH, 2LH, 2HL) and outputs only the lower sub-bands (herein, with decomposition level 4, 3HH, 3LH, 3HL, 4HH, 4LH, 4HL) to the quantization block 106, so as to adjust the resolution for the thumbnail image (e.g., low resolution). On the other hand, when the input image is a full image, the DWT block 105 outputs the sub-bands in the whole range (herein, all sub-bands with decomposition level 4) to the quantization block 106 without omitting any sub-band.

The quantization block 106 applies scalar quantization to the transform coefficients inputted from the DWT block 105 according to quantization step size Ab determined by the image quality control block 52. The image quality control block 52 determines the quantization step size Ab on the basis of the image resolution or amount of image data specified from the operating section 15. The method of quantization by the image quality control block 52 and the quantization block 106 will be described later. The transform coefficients QD outputted from the quantization block 106 undergo block-based entropy coding by the coefficient bit modeling block 108 and the arithmetic coding block 109, and then undergo rate control in the code rate control block 110.

The coefficient bit modeling block 108 divides the band components of the inputted transform coefficients QD into code blocks of, e.g., 16×16, 32×32, or 64×64, and further decomposes each code block into a plurality of bit planes formed of two-dimensional arrangements of bits. As a result, as shown in FIG. 17, each code block is decomposed into a plurality of bit planes 122₀ to 122ₙ₋₁.

The arithmetic coding block 109 applies arithmetic coding to the code data BD inputted from the coefficient bit modeling block 108. Other entropy coding scheme may be adopted in place of the arithmetic coding.

On the basis of an instruction from the image quality control block 52, the code rate control block 110 controls the rate of the code data AD inputted from the arithmetic coding block 109. Specifically, according to a target amount of code (the amount of code of the final compressed image), the code rate control block 110 performs a post-quantization by sequentially truncating the code data AD starting from lower priority, in a band-component by band-component manner, or a bit-plane by bit-plane manner, or a pass by pass manner. The rate control by the code rate control block 110 will be described in detail later. The image quality control block 52 gives the instruction to the code rate control block 109 on the basis of the image resolution or the amount of image data specified from the operating section 15.

The bit stream generating block 111 multiplexes the code data CD inputted from the code rate control block 110 with additional information (header information, layer structure, scalability information, quantization table, etc.), thereby generating a bit stream and providing compressed image data.

When the generated compressed image data is that of a thumbnail image, the bit stream generating block 111 outputs it without filing, and when the generated compressed image data is that of a full image, it outputs the data as a file of a given file format (for example, the JPEG 2000 file format).

<Quantization>

Next, the quantization processing performed by the image quality control block 52 and the quantization block 106 shown in FIG. 5 will be described briefly.

On the basis of target image quality information (high image quality, standard image quality, low image quality, resolution information, etc.) determined according to the image resolution or the amount of image data specified from the operating section 15, the image quality control block 52 has a function of determining quantization step size Δ_{b} for the quantization that is applied by the quantization block 106 to the transform coefficients inputted from the DWT block 105. The method of determining quantization step size Δ_{b} will be described below.

When, as shown in FIG. 16, an original image is divided by the DWT block 105 into sub-bands (band components) of “XYn” (X and Y indicate high-band component H or low-band component L, and n indicates decomposition level), the quantization step size Δ_{b} for the quantization of each sub-band is determined as shown by the expression (1) below.

$${Δ}_{b} = \frac{{Q}_{p}}{{Q}_{b}} \qquad ( 1 )$$

Where Qₚ is a quantization parameter that is inputted according to the target image quality information, which has a smaller value as the image quality becomes higher. Q_{b} is a quantization coefficient in each sub-band.

Q_{b} is represented by the expression (2) below as a norm of composition filter coefficients.
Q_{b}=\sqrt{G_{b}} (2)

The weighting coefficient G_{b} of a sub-band b is an inner product of composition filter coefficients.

In place of the method above, the quantization step size Δ_{b} may be determined while considering human visual sight characteristics. Such a method is described below.

Weighted Mean Square Error (WMSE) based on Contrast Sensitivity Function of human visual system (CSF) is described in Chapter 16 of, David S. Taubman and Michael W. Marcellin, “JPEG2000 IMAGE COMPRESSION FUNDAMENTALS, STANDARDS AND PRACTICE,” Kluwer Academic Publishers (Non-patent Document 1). According to the description, the expression (2) above is modified to the expression (3) below in order to improve human visual evaluation about compression-coded image data.
Q_{b}=\sqrt{W_{b[i]}^{csf}G_{b[i]}} (3)

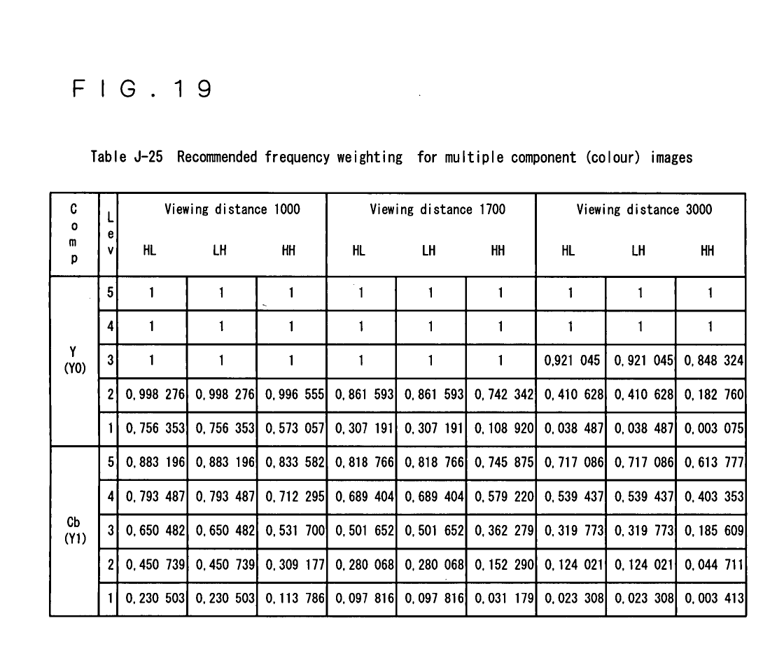

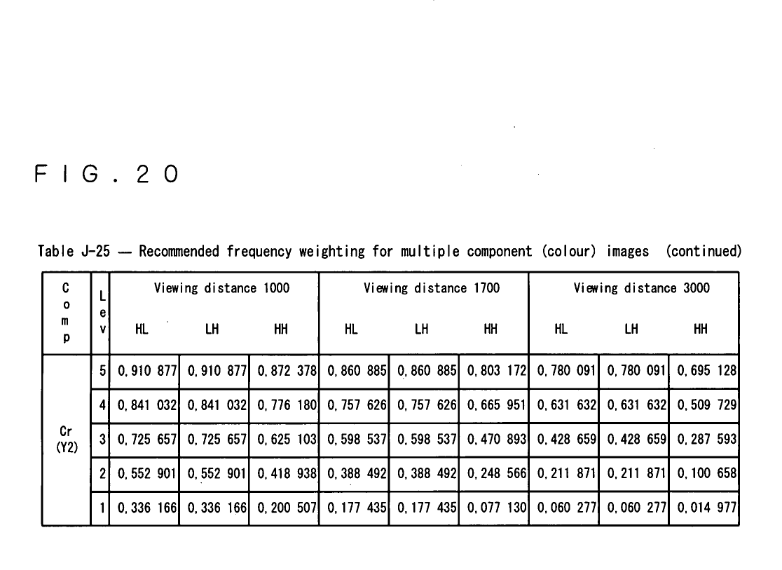

In the expression (3) above, W_{b[i]}^{csf} is called “energy weighting factor” of sub-band b[i], and recommended values of W_{b[i]}^{csf} are shown in ISO/IEC JTC 1/SC 29/WG1 (ITU-T SG8) N2406, “JPEG 2000 Part 1 FDIS (includes COR 1, COR 2, and DCOR3)”, 4 Dec. 2001 (which is hereinafter referred to as Non-Patent Document 2). FIGS. 18 to 20 show values of the energy weighting factor shown in the Non-Patent Document 2.

In FIGS. 18 to 20, “level” and “Lev” indicate decomposition levels and “Comp” indicates luminance component Y and color difference components Cb and Cr, and the diagrams show examples in which “Viewing distance” is 1000, 1700, 2000, 3000, and 4000. The “Viewing distance 1000”, “Viewing distance 1700”, “Viewing distance 2000”, “Viewing distance 3000”, and “Viewing distance 4000” respectively mean viewing distances in which displays or printed matter of 100 dpi, 170 dpi, 200 dpi, 300 dpi, and 400 dpi are viewed at a distance of 10 inches.

The image quality control block 52 obtains quantization step sizes Δ_{b} in this way, and reports them to the quantization block 106. Then, the quantization block 106 applies quantization to each sub-band according to the reported quantization step size Δ_{b}.

It should be noted that, when the value of a quantization step size Δ_{b} is smaller than 1, it is multiplied by a power of 2 so that the value becomes 1 or more, and the quantization step size Δ_{b} of 1 or more is adopted. For example, when the expression (1) gives a quantization step size Δ_{b} of 0.47163, the actual quantization of image data is performed by using a quantization step size Δ_{b}=1.88652 obtained by multiplying the value by 2².

<Setting of ROI Portions>

The ROI block 51 shown in FIG. 5 develops a mask signal (i.e., settings of the regions of interest) provided from the image analysis module 7c of FIG. 1 into the wavelet plane, and gives the setting information about the ROI portions on the wavelet plane to the code rate control block 110.

Now, the development of ROI portions is performed for each code block obtained by dividing the image data, which has been subjected to DWT and developed in the wavelet plane, into rectangular regions of a given size. Specifically, for example, each sub-band is divided into code blocks of a given size, e.g., vertical 32 pixels×horizontal 32 pixels, and the data is developed on the wavelet plane for each code block, indicating whether it is an ROI portion and indicating the priority assigned thereto when it is an ROI portion. When a plurality of ROI portions with different priorities are included in one code block, that code block is handled as belonging to a higher-priority ROI mask.

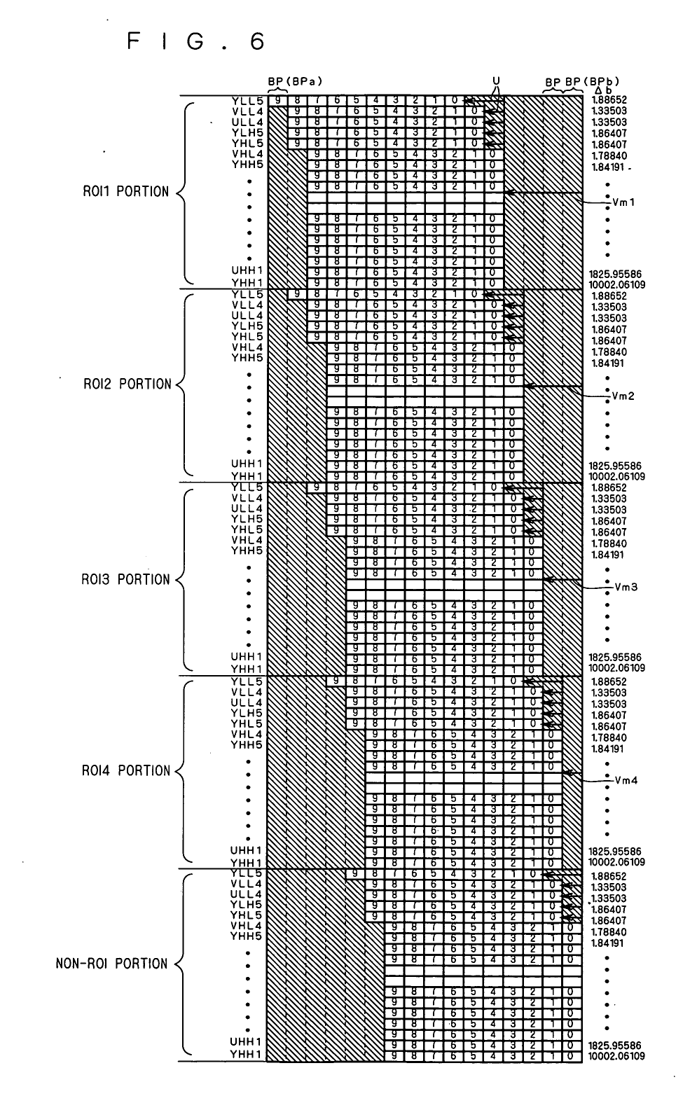

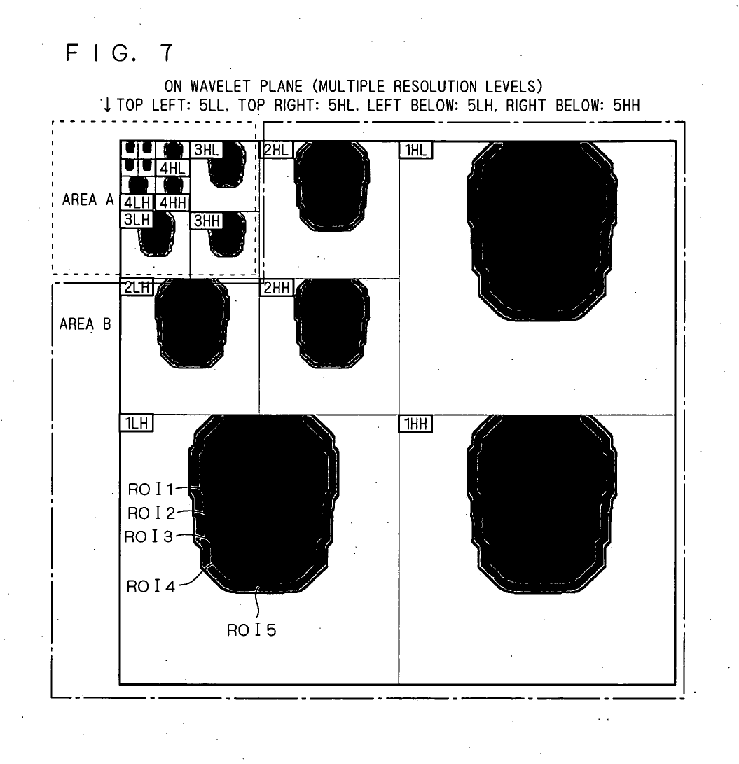

As a result, the wavelet plane as shown in FIG. 7 is developed according to the mask signal (settings of regions of interest) shown in FIG. 2, for example. The setting information about the ROI portions is provided as input to the code rate control block 110.

As mentioned above, when the input image is a thumbnail image, the ROI block 51 omits the higher sub-bands of the input image, i.e., 1HH, 1LH, 1HL, 2HH, 2LH, and 2HL, leaving only the lower sub-bands 3HH, 3LH, 3HL, 4HH, 4LH, and 4HL, and so the setting of regions of interest and their priorities, set by the image analysis module 7c on the sub-band image, is applied only to the lower sub-bands of the input image, like the area A of FIG. 7, for example.

When the input image is a full image, the ROI block 51 does not omit any sub-band of the input image as mentioned above, and so the setting of regions of interest and their priorities, set by the image analysis module 7c on the thumbnail image corresponding to that full image, is applied to all sub-bands, like the area A and the area B of FIG. 7.

<Reordering and Bit Shifting>

The code rate control block 110 shown in FIG. 5 performs reordering and bit shifting of the code data AD inputted from the arithmetic coding block 109, on the basis of the quantization step sizes Δ_{b} reported from the image quality control block 52.

First, when a certain value of quantization parameter Qₚ is specified as the target image quality, the image quality control block 52 calculates the quantization step sizes Δ_{b} in the above-described manner on the basis of the value of the quantization parameter Qₚ, and reports them to the code rate control block 10. Then, according to the values of the quantization step size Δ_{b}, the code rate control block 110 reorders the quantized data pieces in ascending order of values, i.e., starting from smaller value.

As for data that is quantized with a quantization step size Δ_{b} that has been converted to become 1 or more as described above, while the reordering is done on the basis of the converted quantization step size Δ_{b}, the data is bit-shifted to the left by the number of bits corresponding to the exponent of the power of 2 by which the quantization step size Δ_{b} was multiplied for the conversion.

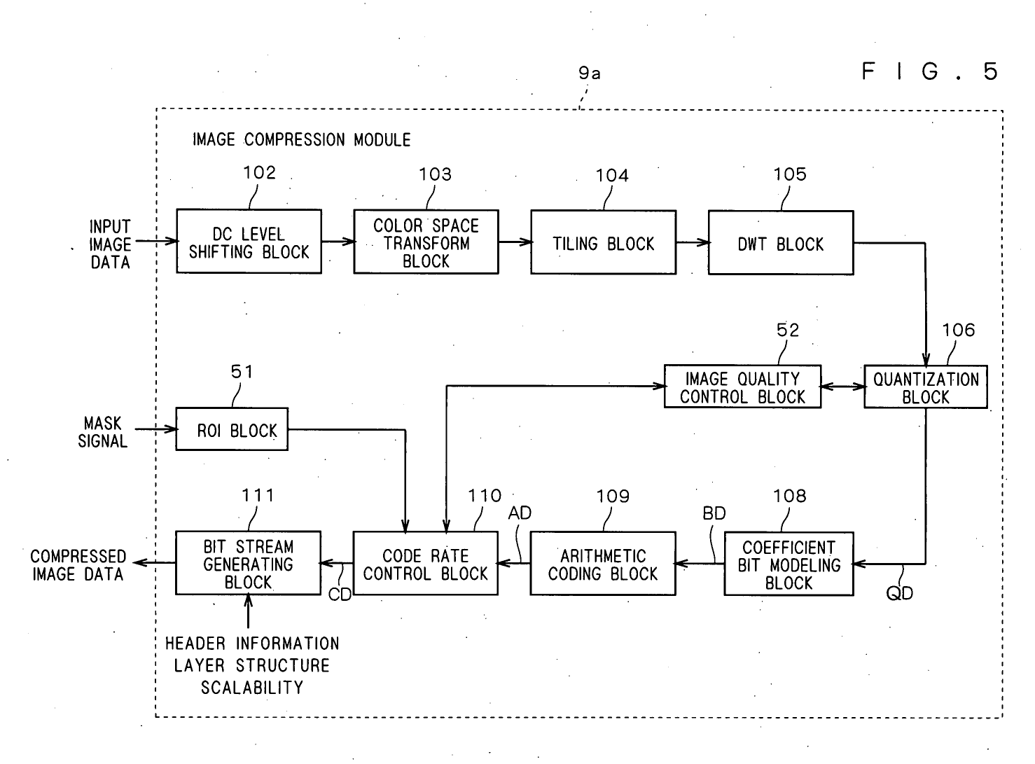

Also, the code rate control block 110 divides the reordered and bit-shifted code rows into ROI data and non-ROI data on the basis of the setting information about the ROI portions reported from the ROI block 51 (the setting information about the regions of interest: FIG. 7). That is to say, as shown in FIG. 6, the code rate control block 10 divides the data into data about the four ROI portions (ROI1 to ROI4) and data about the non-ROI portion, on the basis of the setting information about the ROI portions reported from the ROI block 51 (FIG. 7).

Next, the code rate control block 110 bit-shifts the pieces of data about the ROI portions (ROI1 to ROI4) by given numbers of bits to the left. In this process, a plurality of ROI portions of different priorities are set, and the amount of shift is set larger as the priority is higher. For example, in FIG. 6, with respect to the data about the non-ROI portion, the lowest-priority ROI portion (ROI4) is bit-shifted by 1 bit to the left, and the next, higher-priority ROI portion (ROI3) is shifted by 2 bits to the left, and the next, higher-priority ROI portion (ROI2) is shifted by 3 bits, and the highest-priority ROI portion (ROI1) is shifted by 4 bits to the left.

The amounts of shift of data of the ROI portions (ROI1 to ROI4) may be predetermined numbers of bits, or may be varied to arbitrary values depending on, e.g., the target image quality of the compression-coded image data. Also, the data about the ROI portions (ROI1 to ROI4) and the data about the non-ROI portion may be arranged starting from lower-priority data, for example, instead of starting from higher-priority data as shown in FIG. 6.

The transform coefficients of each sub-band are quantized on the basis of the quantization step size obtained according to an image resolution or amount of image data specified from the operating section 15, and the code rate control block 110 applies the bit-shifting to those quantized transform coefficients as shown above.

More specifically, in the bit shifting, the code rate control block 110 arranges the rows of bits of quantized transform coefficients so that their most significant bits are aligned with each other and their least significant bits are aligned with each other, and so that the transform coefficients belonging to the same regions of interest are grouped together, and shifts the aligned bit rows of quantized transform coefficients in such a way that rows of bits belonging to higher-priority regions of interest are shifted by larger amounts Vmn (Vmn: the amount of shift of a region of interest ROIn) toward the most significant bit (FIG. 6).

<Code Rate Control>

Next, the code rate control block 110 applies omission of data to the reordered and bit-shifted code rows as shown in FIG. 6 so that the total amount of data is within a given amount or the target amount of code. The data is omitted sequentially from a rightmost bit. For example, with the data shown in FIG. 6, data is sequentially omitted downward starting from the bit data of number 0 of VHL4 of the non-ROI portion. Then, when the total amount of data is within the given amount when the bit data has been omitted to number 0 of YHH1, the corresponding data portion is omitted. When the total amount of data is not within the given amount even when data is omitted to number 0 of YHHL, then the data is next omitted sequentially downward from the bit data of number 0 of VHL4 of the ROI portion (ROI4). The omission of bit data is continued sequentially from bits positioned on the right, until the total amount of data is within the target amount of code.

Bit data (a bit plane) can be decomposed into SIG pass, MR pass, and CL pass. The rate control by the code rate control block 110 may be performed pass by pass, instead of bit plane by bit plane.

This rate control is not needed when the total amount of code data AD is already under a user-expected target amount when the data is inputted to the code rate control block 110.

FIG. 6 shows an example of the bit-shifting process applied to a color image including four regions of interest ROI (ROI1 to ROI4) with a viewing distance of 3000 and YUV 422 scheme. In FIG. 6, the rows of bits of quantized transform coefficients belonging to the highest-priority region of interest ROI1 are shifted by the amount of shift Vm1=4, the rows of bits of quantized transform coefficients belonging to the next higher-priority region of interest ROI2 are shifted by the amount of shift Vm2=3, the rows of bits of quantized transform coefficients belonging to the next higher-priority region of interest ROI3 are shifted by the amount of shift Vm3=2, the rows of bits of quantized transform coefficients belonging to the next higher-priority region of interest ROI4 are shifted by the amount of shift Vm4=1, and the rows of bits of quantized transform coefficients belonging to the region of no-interest (non-ROI) 21 in the image, where no region of interest ROI is set, are not shifted. The numbers 0, 1, . . . , 9 attached to the rows of bits in FIG. 6 are bit numbers, where the bit number 0 indicates the LSB and the bit number 9 indicates the MSB.

Also, in FIG. 6, U shows the amounts of shift related to the quantization of transform coefficients. That is, according to the JPEG 2000, for example, when an obtained quantization step size is smaller than 1, that quantization step size is multiplied by 2^{s} (s: a certain positive number) so that the value exceeds 1. However, with a transform coefficient quantized with a quantization step size thus corrected in the increasing direction, the amount of code is reduced to an extra extent by the amount of correction during the quantization, and so the transform coefficient is shifted toward the most significant bit by the amount of shift U=s bits so that the code rate control block 110 omits the code to a less extent, so as to compensate for the extra reduction.

The code rate control block 110 develops the bit-shifted code rows of quantization transform coefficients on a bit-plane BP basis (FIG. 6).

With the rows of bits of quantization transform coefficients developed on a bit-plane BP basis by the coefficient bit modeling block 108 and the arithmetic coding block 109, the code rate control block 110 omits bits sequentially from those placed on a bit plane BP closer to the least significant bit plane BPb, so as to compress the total amount of code of all quantization transform coefficients (i.e., the total amount of code of the input image) to the target amount of code. During this process, rows of bits of quantization transform coefficients belonging to higher-priority regions of interest ROI are shifted by larger amounts toward the most significant bit plane BPa, and therefore less likely to be omitted. That is, in the input image, the amount of code of a higher-priority region of interest ROI will not be reduced or will be reduced by a relatively smaller amount (i.e., a relatively larger amount of code is assigned thereto) so that it is relatively in focus, and the amount of code of a lower-priority region of interest ROI is reduced by a relatively larger amount (i.e., a relatively smaller amount of code is assigned thereto) so that it is relatively more out-of-focus.

The digital diaphragm is thus applied to the image while reducing the amount of code (i.e., while compressing the image) by taking advantage of the image property that image portions assigned larger amounts of code are clearly displayed (with minimum deterioration of image quality) and image portions assigned smaller amounts of code are displayed more “unclearly”.

In this way, the input image provided to the image compression module 9a is compressed (rate-controlled) in such a way that relatively large amounts of code are assigned to the regions of interest ROI1 to ROI5 so that they are relatively in focus, and a relatively small amount of code is assigned to the region of no-interest 21 so that it is relatively out of focus, with lower-priority regions of interest ROI being assigned relatively smaller amounts of code and so relatively more out-of-focus, whereby the input image is image-compressed while digital-diaphragm-processed.

Next, operations of the digital camera 1 will be described referring to FIG. 8.

When the image taking button is depressed in Step 1, the imaging device 3 picks up an image, and the sensor signal processing module 7a applies pre-processing in Step 2 to the image signal of the taken image, and the image processing module 7b generates in Steps 3 full image data and thumbnail image data G1 (FIG. 3) from the pre-processed image signal.

Then, in Step S4, when the digital diaphragm function is previously selected “on” through operation of the operating section 15, the flow moves to Step S5. On the other hand, when the digital diaphragm function is previously selected “off” through operation of the operating section 15, the flow moves to Step S21.

When the flow moves to Step S5 (i.e., when the digital diaphragm function is on in advance), an automatic setting mode can be selected through operation of the operating section 15 to automatically set regions of interest ROI, or a manual setting mode can be selected through operation of the operating section 15 to manually set regions of interest ROI.

When the automatic region-of-interest setting mode is selected in Step S5 through operation of the operating section 15, the image analysis mode 7c, first, in Step S6, automatically extracts an object (a characteristic object herein) 18 (FIG. 4) by, e.g., binarization, from the thumbnail image G1 (FIG. 3) generated in Step S3. Next, the highest-priority region of interest ROI1 is automatically set on the portion occupied by the object 18 (FIG. 2), and next, in Step S7, the ring-like regions of interest ROI2 to ROI4 (FIG. 2) are automatically set around the highest-priority region of interest ROI1 according to a predetermined number (four in FIG. 2) and a predetermined width W of ring-like regions of interest, and then in Step S8, predetermined priorities are automatically set to the regions of interest ROI1 to ROI5 (the priorities are set so that the highest priority is assigned to the highest-priority region of interest ROI1 and the priorities become lower toward outer regions of interest ROI).

On the other hand, when, in step S5, the manual region-of-interest setting mode is selected through operation of the operating section 15, the flow moves to Step S9 where the display device 13 displays the thumbnail image G1 generated in Step S3 (FIG. 3). Then, in Step S10, an object (e.g., a rectangular or circular region) 18 (FIG. 2) is set in a desired portion of the displayed thumbnail image G1 through operation of the operating section 15 (setting of an arbitrary object), and the highest-priority region of interest ROI1 is set in the area occupied by the object 18 (FIG. 2). Next, in Step S11, the operating section 15 is operated to set the number (e.g., four) and the width W of the ring-like regions of interest (setting of arbitrary width), and the ring-like regions of interest ROI2 to ROI5 are further set on the displayed thumbnail image G1 according to the settings (FIG. 2). Then, in Step S12, the operating section 15 is operated to set priorities of the individual regions of interest ROI1 to ROI5 (setting of arbitrary priorities), and according to the settings, the priorities are assigned to the regions of interest ROI1 to ROI5 set on the displayed thumbnail image G1.

After the regions of interest ROI1 to ROI5 have thus been set on the thumbnail image G1, then in step S13, the image compression module 9a applies image compression to the thumbnail image G1 such that the regions of interest ROI1 to ROI5 are assigned relatively large amounts of code and are therefore relatively in focus, such that the region of no-interest (non-ROI) 21 is assigned a relatively small amount of code and is therefore relatively out of focus, and such that lower-priority ones of the regions of interest ROI1 to ROI5 are assigned relatively smaller amounts of code and therefore relatively more out-of-focus, whereby the thumbnail image G1 is image-compressed while digital-diaphragm-processed.

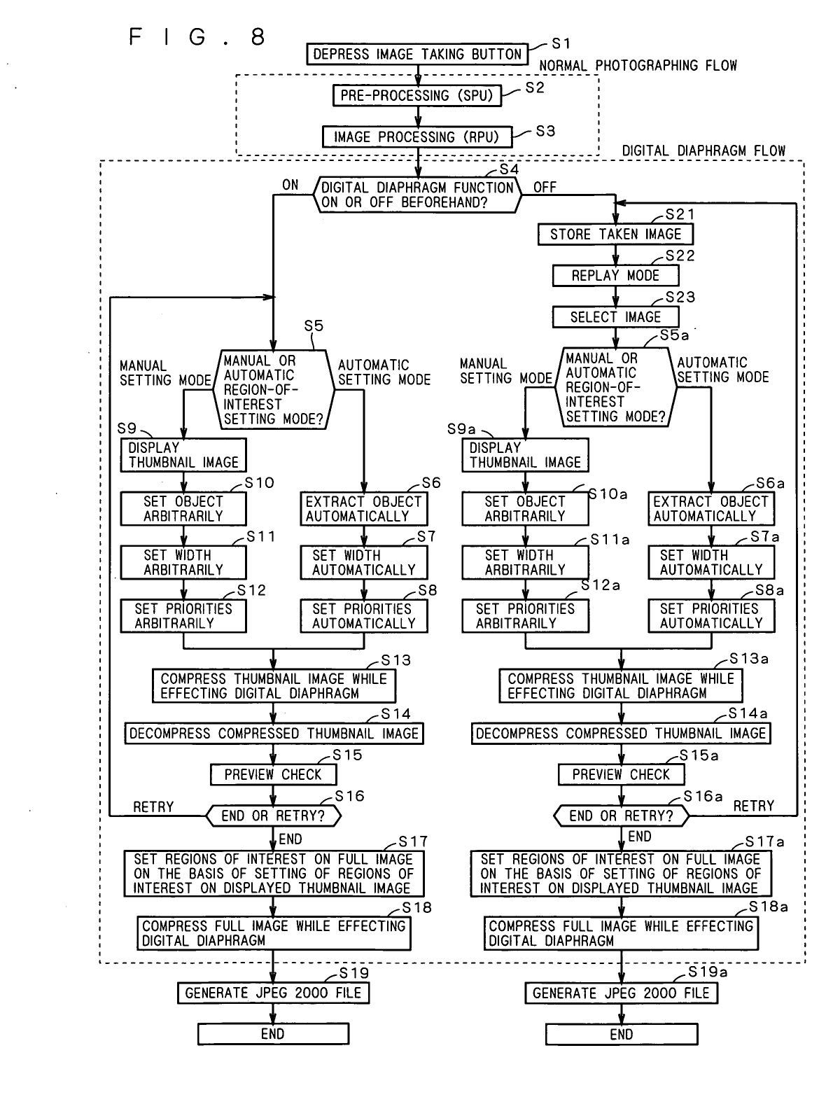

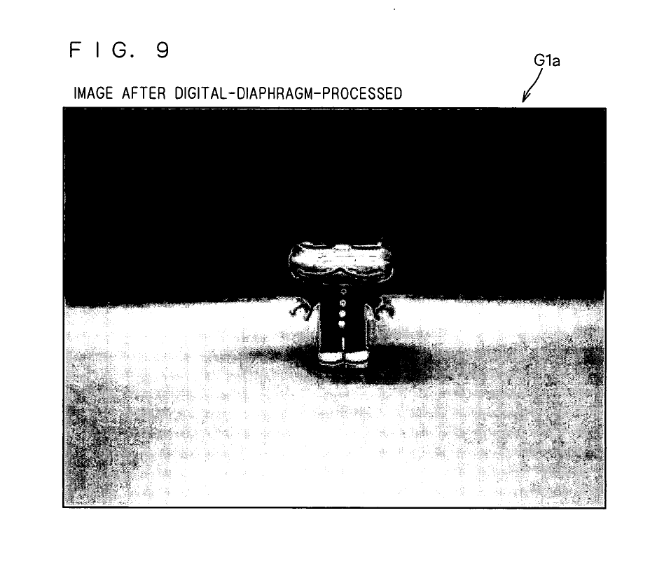

Then, in Step S14, the image decompression module 9b decompresses the thumbnail image G1 compressed in Step S13, i.e., to generate a digital-diaphragm-processed thumbnail image G1a (FIG. 9), and the display device 13 displays in Step S15 the digital-diaphragm-processed thumbnail image G1a. Then, the user sees the thumbnail image G1a displayed on the display device 13 to check the digital diaphragm effect (preview check).

Then, in Step S16, when the result of the preview check in Step S15 indicates that the regions of interest should be re-set, the flow returns to Step S5 to perform the operations of Steps S5 to S15 again, or otherwise a save button of the operating section 15 is depressed in Step S17 to end the setting of regions of interest.

When the save button of the operating section 15 is depressed in Step S17, then, by the image compression module 9a, the setting of the regions of interest on the thumbnail image G1a displayed on the display device 13 is applied to the full image data generated in Step S3 corresponding to the thumbnail image G1a.

Next, in Step S18, according to the setting of the regions of interest set on the full image in Step S17, the image compression module 9a performs the image compression such that the regions of interest ROI1 to ROI5 in the full image are assigned relatively larger amounts of code and are therefore relatively in focus, and such that the region of no-interest 21 of the full image is assigned a relatively small amount of code and therefore relatively out of focus, with lower-priority ones of the regions of interest ROI being assigned relatively smaller amounts of code and therefore relatively more out-of-focus, whereby the full image is image-compressed while digital-diaphragm-processed.

Next, in Step S19, according to a certain file format (e.g., the JPEG 2000 format), the bit stream generating block 111 of the image compression module 9a files the full image data that has been digital-diaphragm-processed and image-compressed in Step S18, and which is stored in the storage device 11.

On the other hand, when, in Step S4, the digital diaphragm function is previously selected “off” through operation of the operating section 15, the flow moves to Step S21 where the full image data and thumbnail image data generated in Step S3 are once stored in the storage device 11. In this way, full image data and its thumbnail image data obtained while the digital diaphragm function is off are all once stored in the storage device 11.

Then, when a replay mode is selected in Step S22 through operation of the operating section 15, desired one of the thumbnail images stored in the storage device 11 can be displayed on the display device 13 through operation of the operating section 15. Then, in Step S23, the operating section 15 is operated to cause the display device 13 to display desired one of the thumbnail images stored in the storage device 11, and the operations of Steps S5a to S19a are applied to the displayed thumbnail image G1 (FIG. 3), and thus the same operations as the Steps S5 to S19 are applied to the full image data corresponding to the displayed thumbnail image G1, whereby the digital-diaphragm-processed and image-compressed full image data is filed according to a given file format (e.g., the JPEG 2000 format) and stored in the storage device 11. The processes of Steps S5a to S19a are not described here because they are the same as the processes of Steps S5 to S19.

As described so far, according to the digital camera 1 equipped with the digital diaphragm system thus configured, the digital diaphragm (focusing effect) is implemented by image compression and thus the focusing effect is achieved without using a diaphragm mechanism. Also, since the digital diaphragm processing is achieved at the same time as the image compression processing, the amount of data processing and the processing time are greatly reduced.

Furthermore, it is possible to suitably apply the digital diaphragm processing to the regions of interest by compressing an image (full image and thumbnail image) while effecting the digital diaphragm, by setting regions of interest ROI1 to ROI5 on the image, and assigning relatively larger amounts of code to the regions of interest ROI1 to ROI5 of the image so that they are relatively in focus, and assigning a relatively smaller amount of code to the region of no-interest 21 of the image so that it is relatively out of focus.

Also, it is possible to apply the digital diaphragm processing to a particular object in an image (full image and thumbnail image) by setting the regions of interest ROI1 to ROI5 to the particular object in the image. It is also possible to automatically extract the particular object from the image by extracting the particular object by image analysis from the image.

Furthermore, it is possible to extract a characteristic object (particular object) from the image by a simple method, by extracting one or more objects from an image (thumbnail image) by binarization and determining the object placed in the center of the image as the characteristic object.

Also, the regions of interest ROI include the highest-priority region of interest ROI1 and one or more (four herein) ring-like regions of interest ROI2 to ROI5 arranged like the growth rings of a tree around the highest-priority region of interest ROI1 and each having a lower priority than the one inside of it, and lower-priority ones of the regions of interest ROI2 to ROI5 are assigned relatively smaller amounts of code and are therefore relatively more out-of-focus, whereby the digital diaphragm effect produces natural impression with gradations.

Also, when the image processing by the image compression module 9a (i.e., the digital diaphragm processing) is applied to a thumbnail image (preview image), the digital diaphragm processing is applied only to lower sub-bands of the image while omitting higher sub-bands, which reduces the amount of data processing and shortens the processing time for the preview.

Also, in the image processing by the image compression module 9a (i.e., in the digital diaphragm processing), part or all of higher sub-bands of an input image are omitted in accordance with a specified image resolution or amount of image data, which allows the digital diaphragm processing to be suitably achieved according to the specified image resolution or amount of image data.

<First Modification>

In the preferred embodiment above, one or more objects are extracted by binarization from an image (thumbnail image) and the one located in the center of the image is defined as a characteristic object (particular object). However, when the digital camera 1 has an AF (autofocus) function, then, among one or more objects extracted from the image by binarization, the one contained in an AF judge block 40 set in the image, as shown in FIG. 10, may be defined as a characteristic object (when there are a plurality of AF judge blocks 40 as shown in FIG. 10, the one contained in the AF judge block 40 in the center, for example). This method, too, is capable of easily extracting a characteristic object from an image.

<Second Modification>

While the preferred embodiment above extracts an object from an image (thumbnail image) by binarization, another extraction scheme employing similarity judgement using histograms may be adopted to extract an object from an image (Japanese Patent Application No. 2003-201106).

That is, as shown in FIG. 11, a histogram analysis is applied to an object image Ia prepared as a target of extraction (e.g., a histogram analysis about hue in the image information about the object image Ia). Also, as shown in FIG. 12, block images I (x, y) of a given size are sequentially extracted from a thumbnail image Ib, with the block's center position (x, y) being shifted vertically and horizontally, and a histogram analysis is applied to the extracted block images I (x, y) (e.g., a histogram analysis about hue in the image information about the block images I (x, y)). Then, the degrees of similarity are obtained between the results of the histogram analysis of the extracted block images I (x, y) and the results of the histogram analysis of the object image Ia, and central positions (x, y) of block images I (x, y) having given or higher degrees of similarity are determined as candidate positions.

Then, as shown with S1 to S7 in FIG. 13, at each candidate position (x, y), block images SI (x, y) of various sizes are extracted with the candidate position (x, y) defined as the center of the blocks, and a histogram analysis is applied to the extracted block images SI (x, y) (for example, a histogram analysis about hue in the image information about the block images SI (x, y)). Then, the degrees of similarity are obtained between the results of the histogram analysis of the extracted block images SI (x, y) and the results of the histogram analysis of the object image Ia, and the block image I (x, y) having the highest degree of similarity is extracted as the target of extraction (object).

Extracting an object from an image through the similarity judgement with histograms is advantageous in that an object can be extracted by considering, e.g., hue in the image information about the object.

<Third Modification>

While the preferred embodiment above extracts an object from an image (thumbnail image) by binarization, another extraction scheme using image matching with Log-Polar transform may be adopted to extract an object from an image (Japanese Patent Application Laid-Open No. 2004-310243).

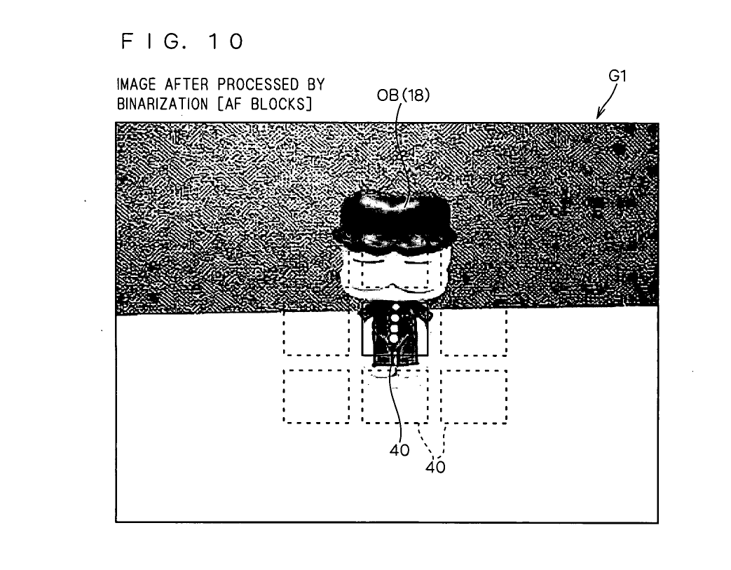

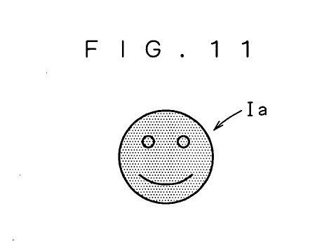

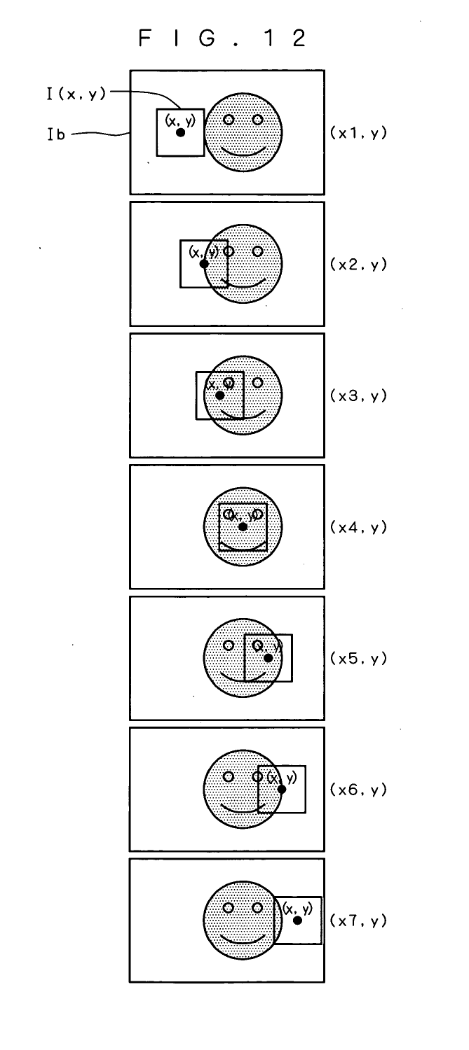

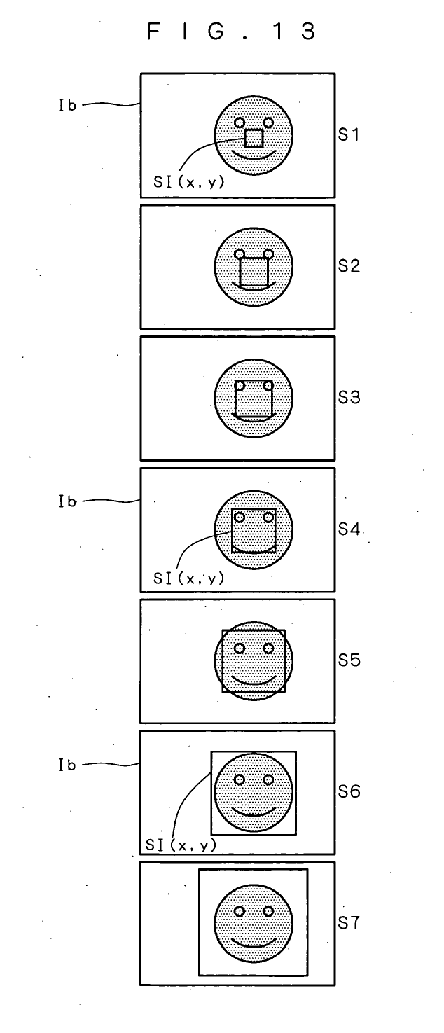

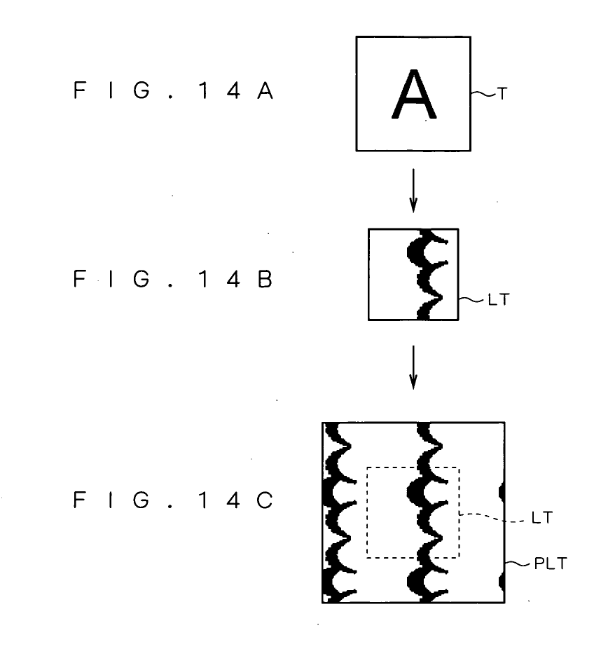

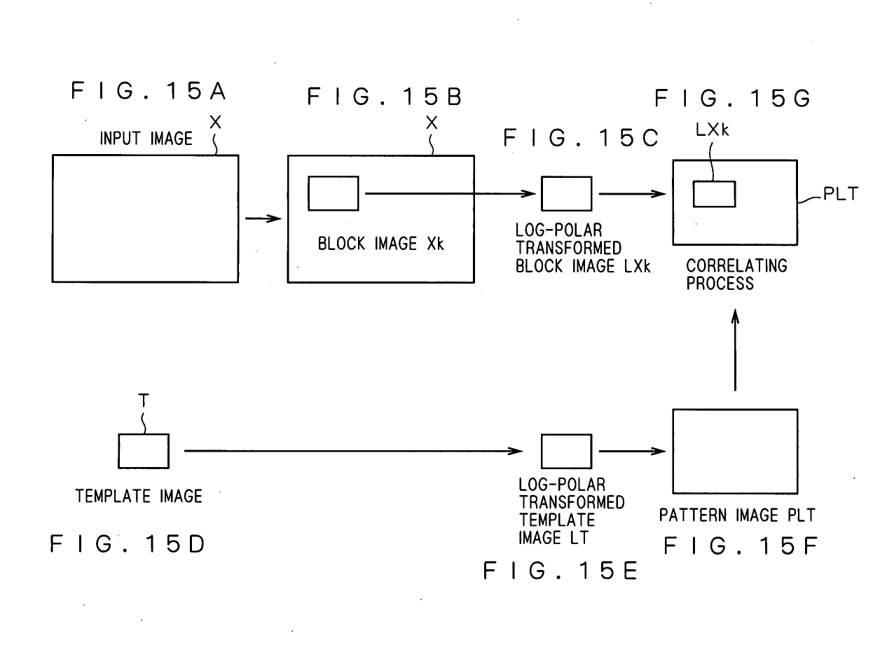

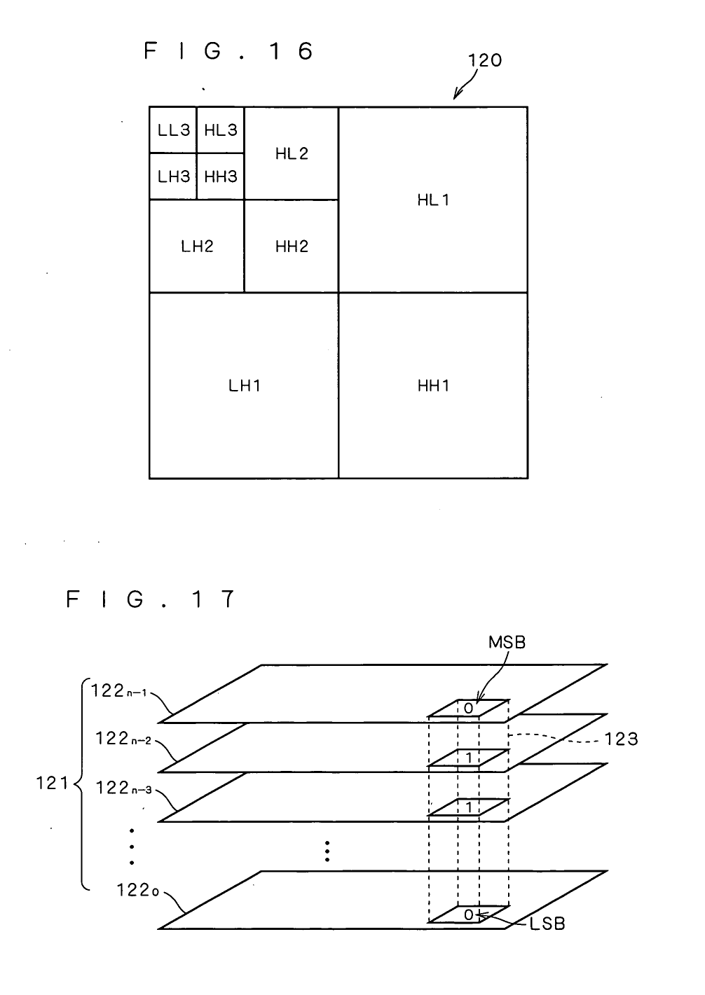

That is, as shown in FIGS. 14A and 15D, a template image T including an image of an object (letter “A” herein) is prepared, and the template image T is Log-Polar transformed as shown in FIGS. 14B and 15E. The Log-Polar transformed template image TL is then repeatedly developed up and down, right and left, and obliquely, so as to generate a pattern image PLT as shown in FIGS. 14C and 15F.

Then, with a thumbnail image X (FIG. 15A), block images Xk are sequentially extracted with the block's center position being shifted vertically and horizontally (FIG. 15B), and the extracted block images Xk are Log-Polar transformed (FIG. 15C). Then, a correlating process is performed between the pattern image PLT and each Log-Polar transformed block image LXk, with the block image LXk being moved in the pattern image PLT (FIG. 15G).

Next, on the basis of the results of the correlating process, among Log-Polar transformed block images LXk having certain or higher degrees of correlation with the pattern image PLT, the block image LXk having the highest degree of correlation is detected (i.e., a block image containing the image of the object is detected), and the matching position of the detected block image LXk in the pattern image PLT is detected (i.e., the position providing the highest degree of correlation in the pattern image PLT is detected).

When an image is Log-Polar transformed, rotation and expansion/shrinkage of an object in the image are represented as parallel displacement in vertical and horizontal directions in the image. On the basis of this property, a determination is made, from the detected matching position, as to how much the image of the object in the detected block image LXk is rotated, and how much it is expanded/shrunk, with respect to the image of the object contained in the template image T.

Then, from the results, a determination is made as to which position in the thumbnail image X contains the object of the template image T (the central position of the detected block image Xk), and of what size and at what rotation angle the object of the template image T is present. Then, the object is extracted from the thumbnail image X on the basis of the results of detection.

In this way, extracting an object from an image by using the image matching scheme with Log-Polar transform is advantageous in that the object can be extracted by considering color and pattern of the object.

While the invention has been described in detail, the foregoing description is in all aspects illustrative and not restrictive. It is understood that numerous other modifications and variations can be devised without departing from the scope of the invention.

What is claimed is:

1. A digital diaphragm system comprising:
region-of-interest setting means for setting a region of interest in an image; and
image compression means for applying a digital diaphragm process to said image by performing an image compression in such a way that said region of interest in said image is assigned a relatively large amount of code and is relatively in focus and a region of no-interest in said image is assigned a relatively small amount of code and is relatively out of focus.

2. The digital diaphragm system according to claim 1, further comprising object extracting means for extracting a particular object from said image by an image analysis,
wherein said region-of-interest setting means sets said region of interest to said object extracted by said object extracting means.

3. The digital diaphragm system according to claim 2, wherein, among one or more objects extracted by binarization from said image, said object extracting means selects an object located in a center of said image as said particular object.

4. The digital diaphragm system according to claim 2, wherein, when an AF (autofocus) judge block is set in said image, said object extracting means selects, as said particular object, an object that is included in the AF judge block of said image from among one or more objects extracted by binarization from said image.

5. The digital diaphragm system according to claim 1, wherein said region of interest includes a highest-priority region of interest having a highest priority and one or more ring-like regions of interest arranged like growth rings of a tree around said highest-priority region of interest and each having a lower priority than an adjacent inner one, and
said image compression means assigns relatively smaller amounts of code to lower-priority ones of the regions of interest so that lower-priority regions of interest are relatively more out-of-focus.

6. The digital diaphragm system according to claim 1, wherein said image compression means recursively frequency-divides said image and performs said digital diaphragm process in a frequency-component by frequency-component manner, and when said image is a preview image, said image compression means omits higher frequency components and applies said digital diaphragm process only to lower frequency components.

7. The digital diaphragm system according to claim 1, wherein said image compression means recursively frequency-divides said image and performs said digital diaphragm process in a frequency-component by frequency-component manner, and said image compression means omits part or all of higher frequency components in accordance with a specified image resolution or amount of image data.
